(19) United States
(12) Patent Application Publication
(10) Pub. No.: US 2018/0132452 A1
(43) Pub. Date: May 17, 2018

(54) PET DE-SHEDDING TOOL

(71) Applicants: Alicia DIONNE, Las Vegas, NV (US); John WANG, Yorba Linda, CA (US); Brandon CHI, Fullerton, CA (US)

(72) Inventors: Alicia DIONNE, Las Vegas, NV (US); John WANG, Yorba Linda, CA (US); Brandon CHI, Fullerton, CA (US)

(21) Appl. No.: 15/816,840

(22) Filed: Nov. 17, 2017

Related U.S. Application Data
(60) Provisional application No. 62/423,374, filed on Nov. 17, 2016.

(51) Int. Cl. A01K 13/00; A46B 9/02; A46B 17/06; A46B 9/06

(52) U.S. Cl. CPC A01K 13/002; A46B 9/023; A46B 2200/1093; A46B 9/06; A46B 17/06

(57) ABSTRACT

A de-shedding tool is provided for removal of loose pet hair, and for removal or loosening of matted and tangled pet hair. The de-shedding tool includes a brush base with a plurality of bristles. The de-shedding tool further includes a perforated plate, having a plurality of perforations, wherein each of the perforations is dimensioned to accommodate one of the plurality of bristles. The perforated plate reciprocates relative to the brush base between a retracted position while the de-shedding tool is in use, and an extended position to enable removal of pet hair trapped during use.

### RELATED APPLICATION

This application claims 35 USC 119 Priority from U.S. Patent Application Ser. No. 62/423,374 filed Nov. 17, 2016, the contents of which are incorporated by reference.

### BACKGROUND

The present invention relates generally to a de-shedding tool for pets, and provides such a tool designed for removal of loose pet hair, and for removal or loosening of matted and tangled pet hair. More specifically, the present de-shedding tool facilitates the fast and relatively easy removal of pet hair from the bristles of the tool by a user.

Conventional pet de-shedding devices typically utilize a relatively sharp metal blade with a plurality of small teeth, arranged in a loop or as a single edge, and connected to a handle. These conventional devices are generally effective at removing loose fur from a top region of a pet's coat, but also pose many disadvantages. One disadvantage of conventional de-shedding devices is that they are designed to perform only the task of de-shedding, and are not designed to brush the pet hair while removing it. In order to remove tangles or mats of hair, a separate tool, such as a pair of scissors, is commonly used prior to the use of a de-shedding tool.

Conventional pet de-shedding devices also often include a razor-like apparatus that may cut the pet's hair, and potentially damage the hair cuticle, the skin, and/or the coat of the pet. Instructions provided with some of these devices recommend limiting the number of strokes during use, due to the potential for rashes, cuts, or abrasions to the pet's skin. Additionally, conventional de-shedding devices are limited, in that they may only be used in the direction of the pet's hair growth. As such, only one segment of the tool engages with the pet's hair, and that segment predominately makes contact with only the top surface of the pet's coat.

Another disadvantage of conventional de-shedding tools is the frequency with which pet hair needs to be removed during each de-shedding session. During use, because of the small surface area of the conventional blade teeth, the teeth quickly become clogged with hair. As a result, a groomer or pet owner needs to frequently remove the trapped pet hair, which is both tedious and time consuming. Likewise, during de-shedding, the pet hair often becomes detached from the pet, but is not held in place by the tool because of the small tooth surface area. The detached hair is suspended in the air, and when it comes to rest on a floor, table or other substrate, clean up by the groomer or pet owner is needed. Similarly, when this happens, the pet may become distracted and may not let the user continue the de-shedding process.

Additionally, some conventional de-shedding tools are equipped with a retractable hair release mechanism. These tools typically have a single flat blade edge with teeth, and a retractable scraping edge, which a user can depress to dislodge hair trapped in the teeth of the blade. However, these retractable mechanisms are often inefficient, requiring several actuations by a user before the hair actually becomes dislodged, Likewise, these retractable mechanisms are often fitted with a small button, which can be uncomfortable to push frequently during use. These tools also have a limited amount of space for storing the collected loose hair. As a result, loosened hair comes off the tool during use, creating a mess.

Finally, handles of conventional de-shedding tools often are not ergonomically compatible, and are difficult or uncomfortable to use.

### SUMMARY

The above-listed needs are met or exceeded by the present de-shedding tool, which facilitates the easy, and relatively user-comfortable removal of loose pet hair, as well as loosening and removal of matted and tangled pet hair. Compared to conventional de-shedders made up of a single, linear row of teeth with a perpendicularly extending thin handle, the relatively large surface area of the present de-shedding tool collects a higher volume of pet hair with less effort. As the user strokes the pet with the present tool, the pet's loose “club hair” clings to a plurality of bristles and becomes trapped. In a preferred embodiment, the present de-shedding tool also features a rigid band, preferably made of stainless steel, with a plurality of deep notches defined between adjacent teeth, where pet hair is also trapped during use. As additional hair is trapped, inner bristles act as temporary storage of the hair until it is released. The shape and configuration of the bristles and notches allows the user to adjust the direction of the tool during use, giving the user the ability to work on several areas of the pet's coat during the session. For example, the user may brush not only in the direction of hair growth, but also against the direction of hair growth in order to remove the loose under coat.

Since the shape of the rigid band follows the circumference of the present tool, the user is able to brush the pet in any direction while controlling of the applied pressure. Therefore, the user can apply more pressure in areas with thicker hair to increase the amount of loose hair that is collected by the tool. Conversely, the user can also reduce the applied pressure when using the tool while brushing in more sensitive areas of the pet.

Captured pet hair is released from the bristles under user control by a reciprocating perforated plate, which remains in a retracted position during de-shedding, but is actuated by a user into an extended position when the user wishes to remove the trapped pet hair. Openings in the perforated plate slidingly engage the bristles, so that as the perforated plate moves from the retracted position to the extended position, pet hair trapped by the bristles and notches is loosened and lifted off the bristles and notches, keeping all of the captured hair intact, allowing for easy and effortless removal by the user.

Unlike many conventional de-shedding tools, the handle of the present tool was designed for enhanced ergonomic comfort. The handle easily fits into the inside of the user's hand, similar to how a computer mouse is held. This configuration also provides the user with more control over brushing direction and pressure during the de-shedding and de-matting process. As such, the entire process is comfortable for both the pet as well as the user. The handle of the present tool is also detachable for cleaning

More specifically, a de-shedding tool is provided for removal of loose pet hair, and for removal or loosening of matted and tangled pet hair. The de-shedding tool includes a brush base with a plurality of bristles. A perforated plate reciprocates relative to the brush base between a retracted position while the de-shedding tool is in use, and an extended position to enable removal of pet hair trapped during use. The perforated plate has a plurality of perforations, wherein each of the perforations is dimensioned to accommodate one of the plurality of bristles.

In another embodiment, a de-shedding tool is provided, and includes a brush base having a plurality of outer bristles, which are disposed about a periphery of the base. The brush base also includes a plurality of inner bristles, which are disposed within the plurality of outer bristles. The de-shedding tool also features a perforated plate having a plurality of perforations. Each of the plurality of perforations is dimensioned to accommodate one of the plurality of inner bristles. Under user control, the perforated plate is configured to reciprocate, relative to the brush base, between a locked retracted position and a locked extended position.

In a further embodiment, a de-shedding tool is provided, and features a brush base having a bristle side with a plurality of bristles, and an opposite mounting side. The de-shedding tool also features a perforated plate having a plurality of perforations. Each of the plurality of perforations is dimensioned to accommodate one of the plurality of bristles. During actuation by the user, the perforated plate is configured to reciprocate, relative to the brush base, between a locked retracted position and a locked extended position. At least one post extends from a rear side of the perforated plate toward the mounting side of the brush base. The at least one post is enclosed by at least one post housing, which extends from the mounting side of the brush base. Finally, the de-shedding tool features an actuation housing, which extends from the mounting side of the brush base, and encloses an actuation mechanism. The actuation mechanism includes a cap, a sliding member fixed to the perforated plate and configured for sliding relative to the actuation housing, a rotating member connected to the sliding member, and a biasing spring that engages the rotating member and urges the rotating member against the sliding member.

### BRIEF DESCRIPTION OF THE DRAWINGS

FIG. 1 is a bottom perspective view of the present de-shedding tool;

FIG. 2 is a fragmentary top perspective view of the present de-shedding tool;

FIG. 3 is a fragmentary exploded top perspective view of the present de-shedding tool;

FIG. 4 is a fragmentary exploded bottom perspective view of the present de-shedding tool;

FIG. 5 is a fragmentary side elevation view of the present de-shedding tool;

FIG. 6 is a partially exploded vertical cross-section of the present de-shedding tool;

FIG. 7 is a fragmentary exploded vertical cross-section of the present de-shedding tool;

FIG. 8 is a fragmentary exploded vertical cross-section of the present de-shedding tool;

FIG. 9 is a fragmentary exploded vertical cross-section of the present de-shedding tool.

### DETAILED DESCRIPTION

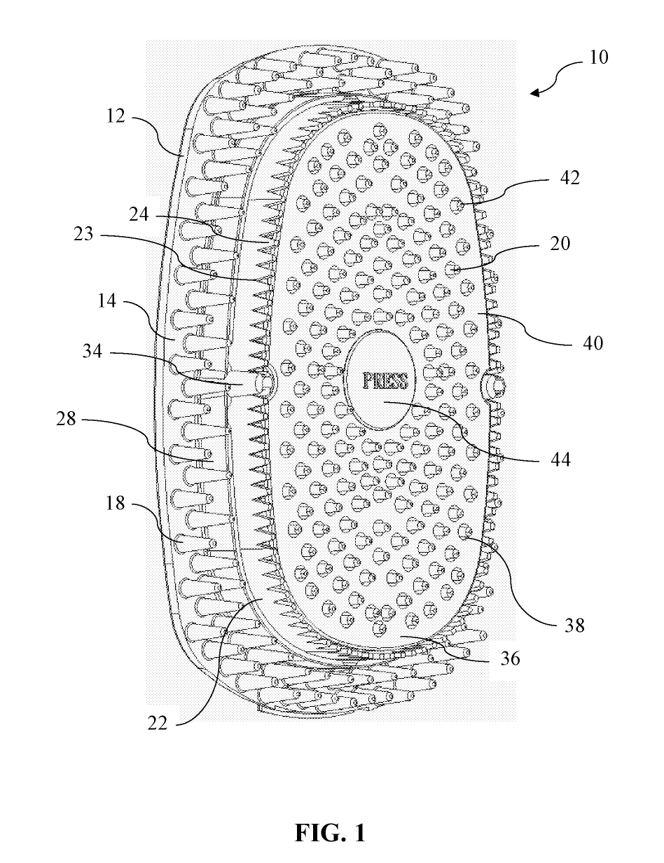

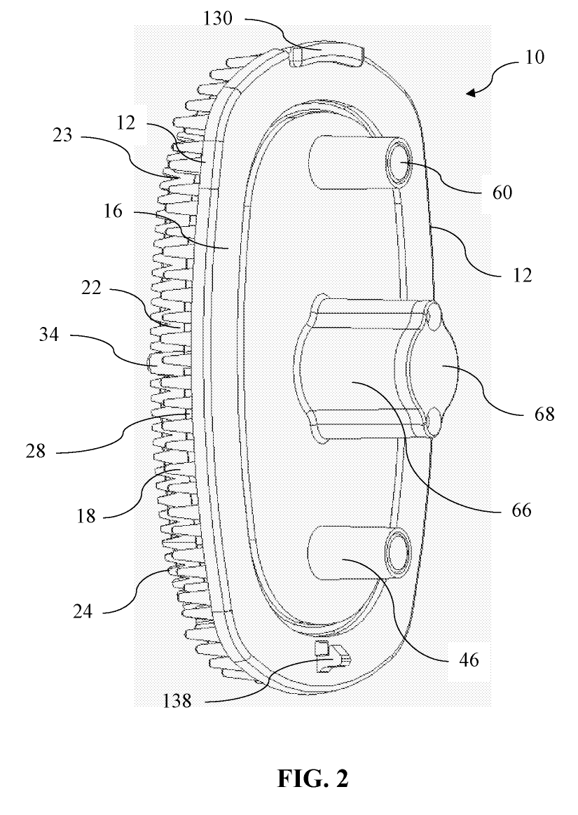

Referring to FIGS. 1 and 2, a preferred embodiment of the present pet de-shedding tool is indicated generally at 10, and includes a brush base 12 having a bristle side 14 and a mounting side 16, opposite the bristle side. In this embodiment, the brush base 12 is generally rectangular and made from a rigid plastic. However, other shapes and materials are also considered. The brush base 12 includes a plurality of bristles that extend from the bristle side 14 of the brush base. A plurality of outer bristles 18 are disposed about a periphery of the brush base 12, and a plurality of inner bristles 20 are disposed within the plurality of outer bristles. Preferably, the inner bristles 20 have a uniform length, while the outer bristles 18 have varying lengths; however, the length or height of the bristles 18, 20 may vary to suit the application. Positioned between the outer bristles 18 and inner bristles 20 is a rigid band 22, preferably metallic, which has a plurality of notches 23. A plurality of teeth 24 are formed between the plurality of notches 23, that extend in the same direction as the inner and outer bristles.

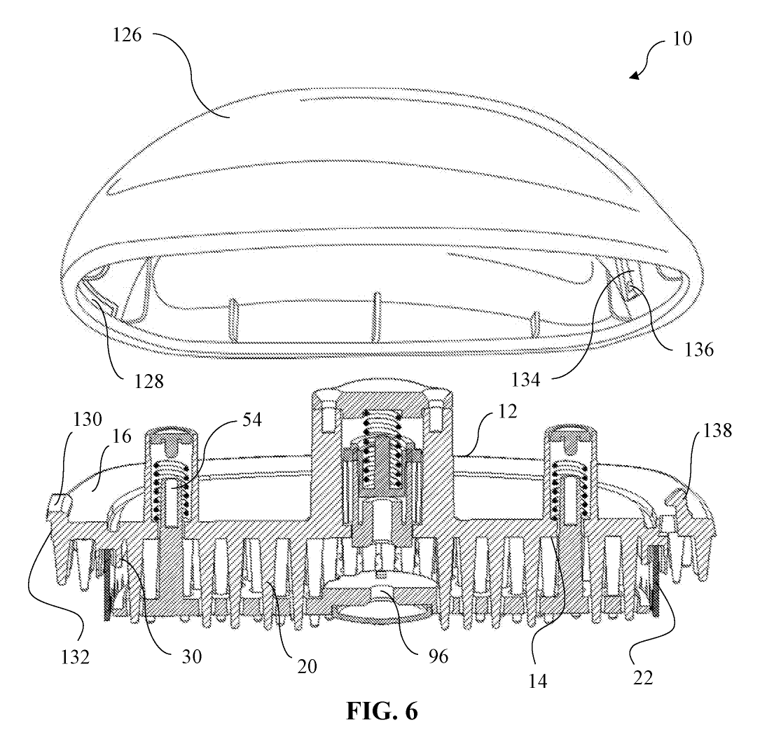

Referring more specifically to FIGS. 1, 3 and 4, in the present embodiment, the rigid band 22 is formed from a pair of semi-circular halves 22a, 22b; however, a rigid band formed from a single, solid piece is also contemplated. The rigid band 22 has a smooth edge 26, opposite the plurality of teeth 24, for enabling installation within a track 28 on the brush base 12. In the preferred embodiment, the track 28 is formed between two side walls 30 (FIG. 6), preferably made from the same rigid material as the brush base 12 as by injection molding or the like, that extend from the bristle side 14 of the brush base in the same direction as the inner bristles 20 and outer bristles 18. The smooth edge 26 of each semi-circular half 22a, 22b of the rigid band 22, is installed within the track 28, and then preferably held in position using chemical adhesives, ultrasonic welding, or other equivalent techniques well known in the art. Opposing ends 32 of the semi-circular halves 22a, 22b are then secured to the brush base 12 at attachment formations 34.

The present de-shedding tool 10 also includes a perforated plate 36, which reciprocates relative to the brush base 12 under user actuation. Included on the plate 36, is a plurality of perforations 38, each of which is dimensioned to slidingly accommodate one of the inner bristles 20. Preferably, the perforations 38 are dimensioned to allow only a small clearance for the inner bristles 20, so that trapped hair is readily removed from the bristles by the plate 36. To enable pet hair to become trapped in the inner bristles 20 and the notches 23 of the rigid band 22, the perforated plate 36 remains in a locked retracted position during use.

When in the retracted position, the perforated plate 36 is dimensioned to fit within a space defined by the rigid band 22. As such, the inner bristles 20 are preferably made from a material sufficiently rigid enough to support the reciprocation of the plate. When in the extended position, a front surface 40 of the perforated plate 36 preferably extends beyond tips 42 of the inner bristles 20, to enable quick and easy removal of collected pet hair from the front surface of the perforated plate.

Also included on the perforated plate 36 is a button cap 44, which defines a space free from the perforations 38 and the inner bristles 20 for the user to engage during actuation, to activate reciprocation of the perforated plate 36 relative to the brush base 12. As best seen in FIG. 1, the button cap 44 preferably includes the word “PRESS” to help the user identify the proper area to engage during actuation, although other designations, designs or logos are also contemplated.

In preparing to brush the pet, the user actuates the perforated plate 36 by depressing the plate until the user receives tactile or audible feedback. Preferably, when the perforated plate 36 has been properly depressed, the user will feel or hear a “click”, indicating he or she may now release their finger from the button cap 44.

When the user is finished brushing the pet and wants to remove the collected hair for disposal, the user causes the perforated plate 36 to reciprocate from the locked retracted position into a locked extended position preferably by placing a finger on the button cap 44, and depressing the perforated plate 36 until the user receives tactile or audible feedback. As such, the perforated plate moves away from the brush base 12 and the tight, sliding engagement of the perforated plate 36 on the inner bristles 20, pulls trapped hair away from the inner bristles. Finally, when a user is ready to use the de-shedding tool 10 again, he or she repeats the process described above, namely, depressing the perforated plate 36 until a “click” is heard or felt, and then releasing the perforated plate. The perforated plate 36 remains in the locked retracted position until it is actuated again by the user.

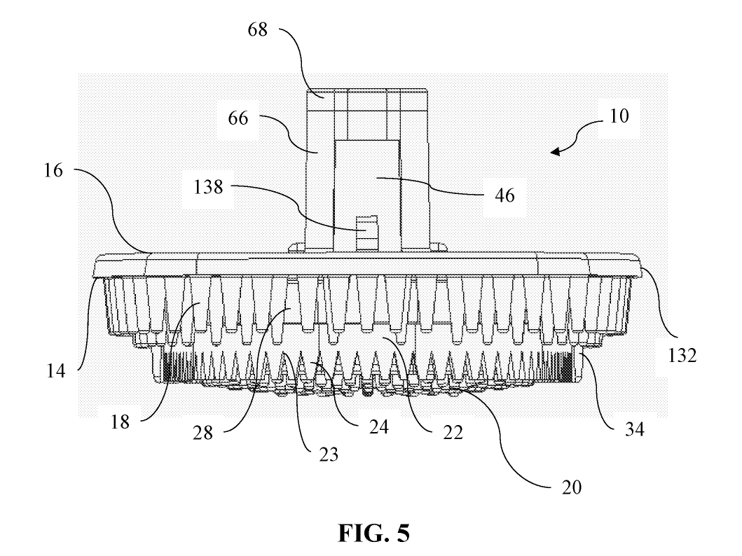

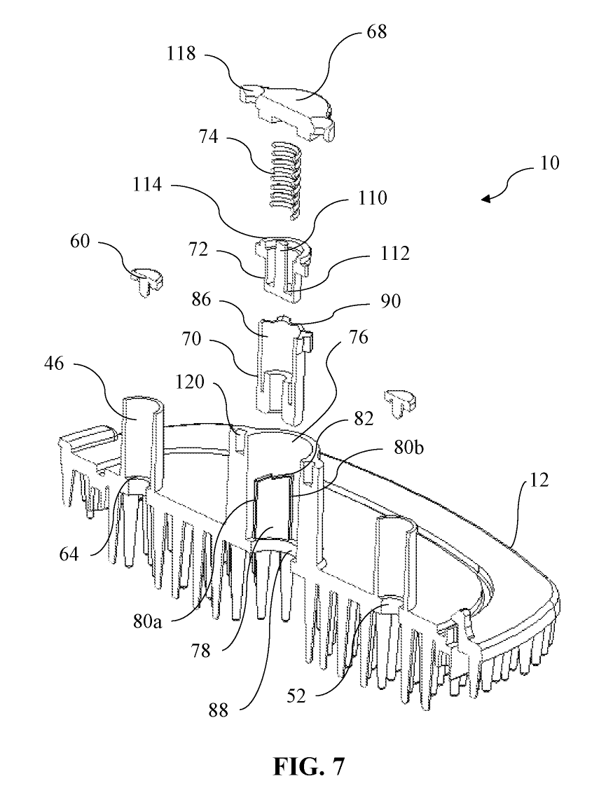

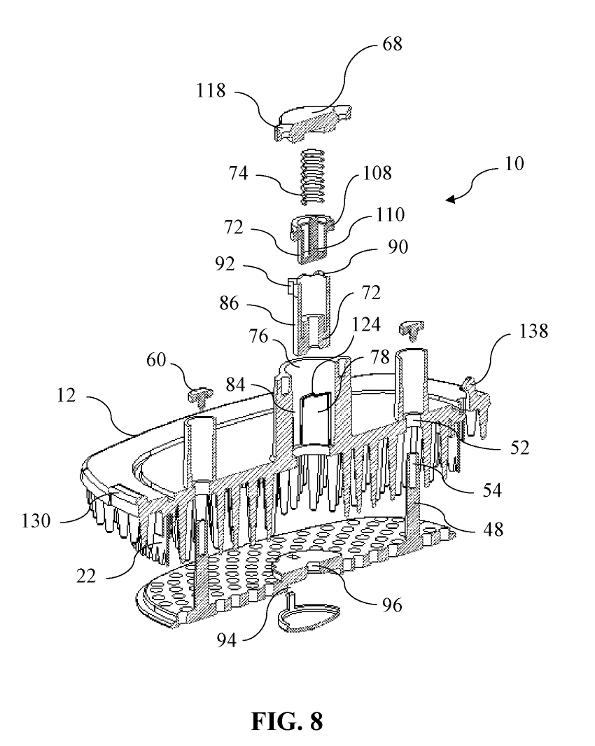

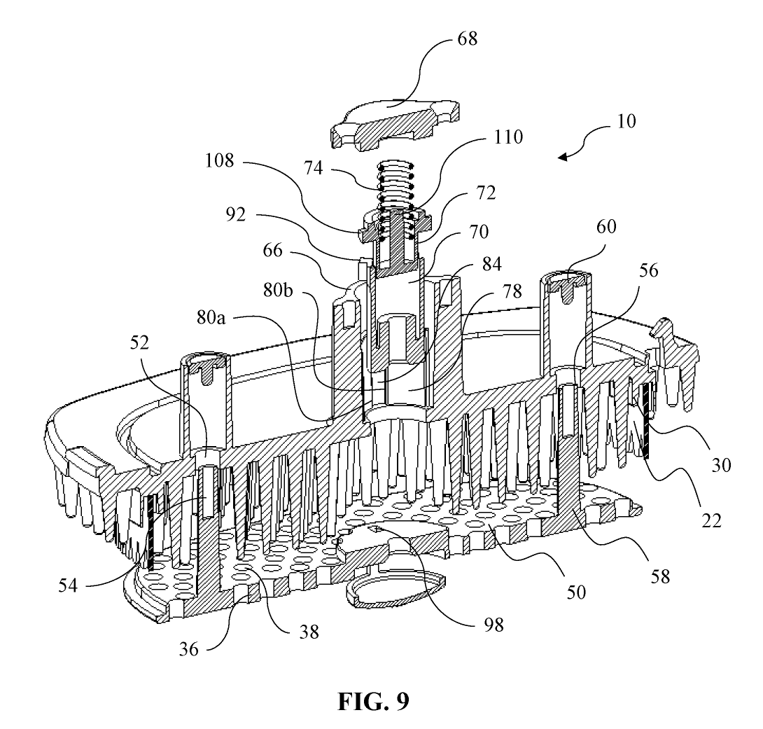

Referring now to FIGS. 2-5 at least one post housing 46 extends from the mounting side 16 of the brush base 12. The at least one post housing 46 is dimensioned to enclose at least one post 48 that extends from, and reciprocates with, a rear side 50 of the perforated plate 36, through at least one corresponding opening 52 (FIGS. 7-9) in the brush base 12, and into the at least one post housing 46. As best seen in FIG. 8, each post 48 also has a counter-bore 54 extending from a plug end 56 toward a plate end 58, and configured to accommodate insertion of a plug 60. Each post housing 46 includes a biasing element 62. Preferably, the biasing element 62 is a coiled spring, however other types of springs are contemplated. The biasing element 62 is seated at a base 64 (FIG. 7) of the post housing 46, and is retained in the post housing by the plug 60. In the preferred embodiment, the biasing element 62 is configured to bias the perforated plate 36 in the extended position.

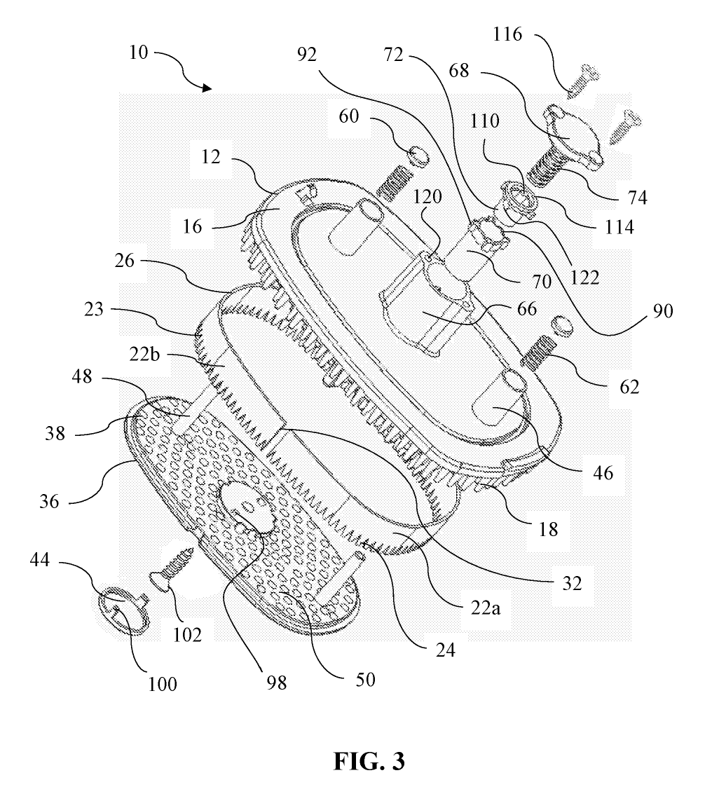

As best shown in FIG. 2, an actuation housing 66 extends from the mounting side 16 of the brush base 12. Preferably, while variations are contemplated, the actuation housing 66 is located in the center of the brush base 12, and each post housing 46 is located equidistant from the actuation housing. Referring now to FIGS. 3, 7 and 9, the actuation housing 66 includes a cap 68, and houses a sliding member 70 configured for sliding relative to the actuation housing, a rotating member 72 configured to engage the sliding member, and a biasing element 74 configured to engage the rotating member and to urge the rotating member against the sliding member. Preferably, the biasing element 74 is a coiled spring, however other types of springs are contemplated.

The actuation housing 66 has an interior surface 76 (FIG. 7) that defines a preferably cylindrical chamber, and has a plurality of radially inwardly projecting formations 78. Each of the formations 78 has a pair of vertical side walls 80a, 80b connected by an arcuate inclined notched landing 82. A plurality of vertical channels 84 are formed between opposing side walls 80a, 80b of adjacent formations 78. The channels 84 and landing 82 define travel paths for the sliding member 70 and the rotating member 72.

Referring now to FIGS. 3, 4, 7 and 8, the sliding member 70 has a generally tubular body 86 dimensioned to reciprocate within an opening 88 of the brush base 12. The sliding member 70 has an undulating cammed top surface 90, and a plurality of radially projecting sliding lugs 92. Each sliding lug 92 is dimensioned to slidably reciprocate within one of the vertical channels 84 during reciprocation of the perforated plate 36.

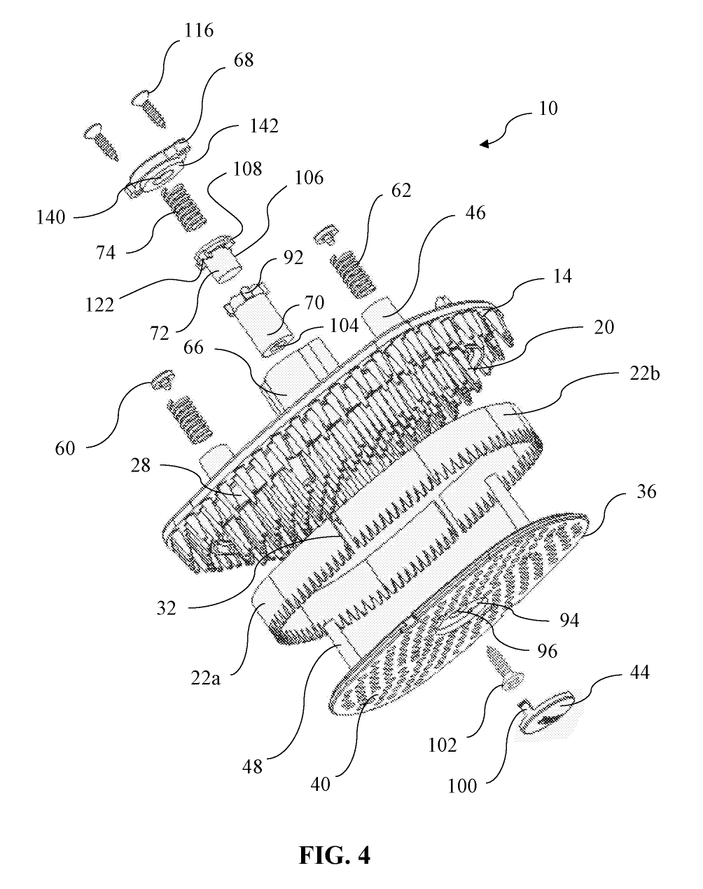

As best shown in FIG. 4, during assembly of the de-shedding tool 10, the sliding member 70 is fixed to the perforated plate 36 to enable simultaneous reciprocation of both pieces during use. The perforated plate 36 includes a recess area 94 from the front surface 40 of the perforated plate, dimensioned to accommodate the button cap 44, and having a central fastening bore 96, and a plurality of snap openings 98 (FIG. 3) dimensioned to accommodate a plurality of button cap hooks 100. The sliding member 70 is fixed to the perforated plate 36 using a fastener 102, preferably a screw, which is inserted through the central fastening bore 96 and into a fastening bore 104 of the sliding member. Once the perforated plate 36 and the sliding member 70 have been fastened together, the button cap 44 is snappingly engaged on the perforated plate by inserting the button cap hooks 100 into the corresponding snap openings 98 (FIG. 3).

Referring again to FIGS. 4 and 7, the rotating member 72 has a generally tubular body 106 dimensioned to nest, at least partially, within the sliding member 70. The rotating member 72 has a plurality of radially projecting rotation lugs 108, extending generally parallel to a longitudinal axis of the sliding member 70, and having a shape complementary to the undulating cammed top surface 90 of the sliding member. The rotating member 72 also has a cylindrical spring post 110 dimensioned to accommodate the biasing element 74 and extending from a bottom surface 112 of the rotating member toward an opposite top end 114.

The sliding member 70, the rotating member 72 and the biasing element 74 are retained in the actuation housing 66 by the cap 68, which is fastened to the actuation housing 66 using a plurality of fasteners 116, preferably screws. Each fastener 116 is inserted through a beveled opening 118, and into a corresponding threaded bore 120 in the actuation housing 66. An inner surface 142 of the cap 68 includes a recess 140 dimensioned for seating the biasing element 74. Once the cap 68 is fastened to the actuation housing 66, the biasing element 74 exerts a longitudinal biasing force onto the rotating member 72, which is consequently urged against the sliding member 70.

Referring now to FIGS. 4, 7 and 8, while the perforated plate 36 is in the locked extended position, the sliding lugs 92 and the rotating lugs 108 are positioned on top of each other in selected channels 84. During actuation of the perforated plate 36 from the extended position to the retracted position, the sliding member 70, the sliding lugs 92, the rotating member 72, and the rotating lugs 108 are urged in the same direction as the perforated plate. Each of the rotating lugs 108 has an angled edge 122 dimensioned to matingly engage both the arcuate incline of the landings 82 and the undulating cammed top surface 90 of the sliding member 70.

When the user fully depresses the perforated plate 36, the rotating lugs 108 exit the selected channels 84 and, under the biasing force of the biasing element 74, begin to slide against sliding lugs 92. The release of the rotating lugs 108 from the selected channels 84 produces the audible or tactile “click”, which signals to the user that the perforated plate 36 has been properly actuated. As the user releases the perforated plate 36, the rotating lugs 108 continue to slide along the arcuate landing 82, causing the rotating member 72 to rotate until the rotating lugs 108 contact a notch 124 in the landing surface. The perforated plate 36 is now in its locked retracted position.

While the perforated plate 36 is in the locked retracted position, the sliding lugs 92 remain in the selected channels 84 and the rotating lugs 108 are positioned against the notch 124 in the surface of the landing 82. During actuation of the perforated plate 36 from the retracted position to the extended position, the sliding member 70, the sliding lugs 92, the rotating member 72, and the rotating lugs 108 are urged in the same direction as the perforated plate. When the user fully depresses the perforated plate 36, the sliding member 70 urges the rotating member 72 toward the cap 68, releasing rotating lugs 108 from the notch 124. Under the biasing force of the biasing element 74, the rotating lugs 108 begin to slide against the landing 82. The release of the rotating lugs 108 from the notch 124 produces the audible or tactile “click”, which signals to the user that the perforated plate 36 has been properly actuated. As the user releases the perforated plate 36, the rotating lugs 108 continue to slide along the landing 82, causing the rotating member 72 to rotate until the rotating lug 108 enters the selected channel 84. The perforated plate 36 is now in its locked extended position.

Referring again to FIG. 6, the present de-shedding tool 10 also includes a housing 126, which has an inner wall recess 128 dimensioned to accommodate a complementary ledge 130 extending from the mounting side 16 and beyond a peripheral edge 132 of the brush base 12. The housing 126, which facilitates user gripping and manipulation of the present de-shedding tool 10, also includes a latch tab 134 at an opposite end of the housing from the inner wall recess 128. The latch tab 134 includes an opening 136 dimensioned to accommodate a latch 138 on the brush base 12. To attach the housing 126 to the brush base 12, the ledge 130 is inserted into the corresponding inner wall recess 128, and the latch 138 is snapped into the opening 136 of the latch tab 134.

While a particular embodiment of the present de-shedding tool has been described herein, it will be appreciated by those skilled in the art that changes and modifications may be made thereto without departing from the invention in its broader aspects and as set forth in the following claims.

1. A de-shedding tool, comprising:
a brush base having a plurality of bristles; and
a perforated plate having a plurality of perforations, each of said plurality of perforations dimensioned for accommodating one of said plurality of bristles, and being configured to reciprocate relative to said brush base between a retracted position and an extended position.

2. The de-shedding tool of claim 1, wherein said perforated plate further comprises at least one post extending from a rear surface of said perforated plate through a corresponding opening in said brush base.

3. The de-shedding tool of claim 2, wherein said brush base further comprises at least one post housing extending from a mounting side of said brush base for enclosing said at least one post, said at least one post having a counterbore configured for accommodating insertion of a plug.

4. The de-shedding tool of claim 3, wherein said at least one post housing further includes a biasing spring retained in said housing by said plug, and configured to bias the perforated plate in a retracted position.

5. The de-shedding tool of claim 1, further including an actuation mechanism associated with said brush base, and wherein said perforated plate reciprocates under user actuation between said retracted position and said extended position using said actuation mechanism.

6. The de-shedding tool of claim 5, wherein said actuation mechanism is enclosed by an actuation housing on said brush base and comprises a sliding member fixed to said perforated plate and configured for sliding relative to said actuation housing, a rotating member connected to said sliding member, and a biasing spring engaging said rotating member and urging said rotating member against said sliding member.

7. The de-shedding tool of claim 6, wherein said biasing spring biases said rotating member against said sliding member.

8. The de-shedding tool of claim 6, wherein said actuation housing has an inner wall defining a chamber, said inner wall having a plurality of radially inwardly projecting formations for slidably engaging and defining a travel path for said rotating member and said sliding member.

9. The de-shedding tool of claim 8, wherein each of said plurality of formations has two vertical side walls connected by an arcuate inclined notched landing, and wherein a plurality of vertical channels is defined between opposing side walls of adjacent said formations.

10. The de-shedding tool of claim 9, wherein said sliding member is generally tubular in shape, having an undulating cammed top surface and a plurality of radially projecting sliding lugs, each dimensioned to slidably reciprocate within a selected one of said plurality of vertical channels.

11. The de-shedding tool of claim 10, wherein said rotating member is dimensioned to nest at least partially within said sliding member, said rotating member having a plurality of radially projecting rotating lugs extending generally parallel to a longitudinal axis of said sliding member and having a shape complementary to said top surface of said sliding member.

12. The de-shedding tool of claim 1, wherein said plurality of bristles includes a plurality of outer bristles disposed about a periphery of said brush base, and a plurality of inner bristles disposed within said plurality of outer bristles.

13. The de-shedding tool of claim 12, further including a rigid band having a plurality of notches defined between adjacent teeth, and being positioned on said brush base between said plurality of inner bristles and said plurality of outer bristles, so that said teeth extend in a same direction as said plurality of bristles.

14. A de-shedding tool, comprising:
a brush base having a bristle side with a plurality of bristles and an opposite mounting side;
a perforated plate having a plurality of perforations, each of said plurality of perforations dimensioned for accommodating one of said plurality of bristles, and being configured to reciprocate relative to said brush base between a retracted position and an extended position;
at least one post housing extending from said mounting side of said brush base for enclosing at least one post, said at least one post extending from a rear side of said perforated plate toward said mounting side; and
an actuation housing extending from said mounting side of said brush base for enclosing an actuation mechanism, said actuation mechanism including a cap, a sliding member fixed to said perforated plate and configured for sliding relative to said actuation housing, a rotating member connected to said sliding member, and a biasing spring engaging said rotating member and urging said rotating member against said sliding member.

15. A de-shedding tool, comprising:
a brush base having a plurality of outer bristles disposed about a periphery of said base and a plurality of inner bristles disposed within said plurality of outer bristles;
a rigid band having a plurality of notches defined between adjacent teeth, positioned between said plurality of inner bristles and said plurality of outer bristles; and
a perforated plate having a plurality of perforations, each of said plurality of perforations dimensioned for accommodating one of said plurality of inner bristles, and being configured to reciprocate relative to said brush base under user control between a locked retracted position and a locked extended position.

16. The de-shedding tool of claim 15, wherein, when in said retracted position, said perforated plate is dimensioned to fit within a space defined by said rigid band.

17. The de-shedding tool of claim 15, wherein said plurality of inner bristles has a uniform length and said plurality of outer bristles have varying lengths.
